(19) United States
(12) Patent Application Publication
(10) Pub. No.: US 2019/0095728 A1
(43) Pub. Date: Mar. 28, 2019

(54) INFRASTRUCTURE DETECTION DEVICE FOR A VEHICLE, METHOD FOR GENERATING A SIGNAL, AND METHOD FOR PROVIDING REPAIR INFORMATION

(71) Applicant: Robert Bosch GmbH, Stuttgart (DE)

(72) Inventor: Holger Mielenz, Ostfildern (DE)

(21) Appl. No.: 16/081,563

(22) PCT Filed: Jan. 27, 2017
(86) PCT No.: PCT/EP2017/051850

§ 371 Date: Aug. 31, 2018

(30) Foreign Application Priority Data
Mar. 10, 2016 (DE) 10 2016 203 959.8

(51) Int. Cl. G06K 9/00; G08G 1/097; G06T 7/00

(52) U.S. Cl. CPC G06K 9/00818; G06T 7/0002; G06K 9/00825; G08G 1/097

(57) ABSTRACT

The approach presented here relates to an infrastructure recognition device for a vehicle. The infrastructure recognition device includes at least one sensor unit for acquiring at least one item of infrastructure information that represents at least one actual constructive feature of an infrastructure device. In addition, the infrastructure recognition device has an interface to at least one item of target infrastructure information that represents at least one target constructive feature of the infrastructure device. Finally, the infrastructure recognition device includes a comparator unit for comparing the item of infrastructure information with the item of target infrastructure information, the comparator unit being designed to produce a signal when a specified relation exists between the item of infrastructure information and the target item of infrastructure information.

### FIELD OF THE INVENTION

The present approach is based on an infrastructure recognition device, a method for producing a signal, and a method for providing an item of repair information. The subject matter of the present approach is also a computer program.

### BACKGROUND INFORMATION

Currently known driver assistance systems are increasingly automated, and, in the context of this trend, are equipped with more extensive sensor systems that enable a more detailed recognition of the surrounding environment of the vehicle. At the same time, in research prototypes of highly automated and fully automated vehicles, it is known that the use of a highly precise digital map is required for functional implementation.

Thus, for example on-board video sensors having corresponding software products are already being used to recognize potholes during travel, and to provide this information to the local authorities.

### SUMMARY

Against this background, the approach presented here provides an infrastructure recognition device, as well as a method for producing a signal, a method for providing an item of repair information, and, finally, a corresponding computer program, according to the main claims. Through the features indicated in the dependent claims, advantageous developments and improvements of the infrastructure recognition device indicated in the independent claim are possible.

An infrastructure recognition device for a vehicle is presented. The infrastructure recognition device includes at least one sensor unit for acquiring at least one item of infrastructure information that represents at least one actual constructive feature of an infrastructure device. In addition, the infrastructure recognition device has an interface for reading in at least one target item of infrastructure information that represents at least one target constructive feature of the infrastructure device. Finally, the infrastructure recognition device includes a comparator unit for comparing the item of infrastructure information with the target item of infrastructure information, the comparator unit being designed to produce a signal when there exists a specified relation between the item of infrastructure information and the target item of infrastructure information.

The infrastructure device can for example be a traffic sign or a light signal such as a traffic light. The specified relation between the infrastructure information and the target infrastructure information can for example be determined in such a way that the signal is produced when the infrastructure information does not correspond to the target infrastructure information. The item of infrastructure information and the target item of infrastructure information can for example be a position of the (for example) traffic sign. Accordingly, the signal is produced if the position of the traffic sign detected by the sensor unit does not correspond to a target position as expected. This would be the case for example if the traffic sign was bent and/or removed.

The presented approach can contribute to traffic safety, for example by communicating the signal to a responsible road construction office as a warning signal.

The infrastructure recognition device can advantageously have a location unit for locating the infrastructure recognition device. A location unit can for example provide, in addition to the signal, a precise item of location information, such as the geographical position of the item of infrastructure information. In this way, the finding of the for example bent traffic sign, and associated repair work, can be accelerated.

According to a specific embodiment, the sensor unit can have a camera interface to a camera, and the sensor unit can be designed to optically acquire the item of infrastructure information. The optical acquisition of the infrastructure information permits optical documentation of the infrastructure information through, for example, a video recording or a video image. The degree of damage, possibly requiring repair, to the infrastructure device can be quickly acquired by such a video recording or video image, for example by an employee of the roadway construction office.

The comparator unit can be designed to wirelessly send, in response to the signal, an item of repair information to a receive location external to the vehicle. The remedying of damage that may require repair to the infrastructure device can be accelerated in this way. The receive location can for example be the roadway construction office.

In addition, it is advantageous if the item of repair information includes at least one video image of the infrastructure information. The degree of damage that may require repair to the infrastructure device can in this way be quickly acquired, for example by an employee of the roadway construction office.

The interface can be designed to provide the target item of infrastructure information using a traffic infrastructure map. The target infrastructure information required for the comparator unit can be stored and/or entered in the traffic infrastructure map. A comparison of the infrastructure information with the target infrastructure information can be facilitated in this way.

The traffic infrastructure map can advantageously represent, or form, a 3-D traffic infrastructure map. Because a 3-D traffic infrastructure map represents the real infrastructure, differences between the item of infrastructure information and the target item of infrastructure information can easily be detected.

A method for producing a signal includes the following steps:
acquiring at least one item of infrastructure information that represents at least one actual constructive feature of an infrastructure device;
comparing the item of infrastructure information with a target item of infrastructure information that represents at least one target constructive feature of the infrastructure device; and
producing the signal if there exists a specified relation between the item of infrastructure information and the target item of infrastructure information.

A method for providing an item of repair information includes the following steps:
receiving a signal according to a specific embodiment of the approach presented here;
evaluating the signal; and
outputting an item of repair information having location information of the infrastructure device to be repaired.

This method can for example be implemented in software or hardware, or in a mixed form of software and hardware, for example in a control device.

In addition, the approach presented here provides a device that is designed to carry out, control, or realize the steps of the method presented here for providing an item of repair information in corresponding devices. The task on which the approach is based can also be achieved quickly and efficiently by this variant embodiment of the approach in the form of a device.

For this purpose, the device can have at least one computing unit for processing signals or data, at least one storage unit for storing signals or data, at least one interface to a sensor or to an actuator for reading in sensor signals from the sensor or for outputting data signals or control signals to the actuator, and/or at least one communication interface for reading in or outputting data that are embedded in a communication protocol. The computing unit can for example be a signal processor, a microcontroller, or the like, and the storage unit can be a flash memory, an EPROM, or a magnetic storage unit. The communication interface can be designed to read in or output data wirelessly and/or in wire-bound fashion, and a communication interface that can read in or output wire-bound data can read in these data for example electrically or optically from a corresponding data transmission line, or can output them to a corresponding data transmission line.

In the present context, a device can be understood as an electrical apparatus that processes sensor signals and outputs control signals and/or data signals as a function thereof. The device can have an interface that can be fashioned as hardware and/or as software. In the case of a realization as hardware, the interfaces can for example be part of a so-called system ASIC that contains a wide variety of functions of the device. However, it is also possible for the interfaces to be separate integrated circuits, or to be made up at least partly of discrete components. In the case of a realization as software, the interfaces can be software modules present for example on a microcontroller alongside other software modules.

In a preferred embodiment, the device carries out a controlling of an item of repair information. For this purpose, the device can for example access sensor signals, such as the signal of an infrastructure recognition device. The controlling takes place via actuators, such as an evaluation unit of the device.

Also advantageous is a computer program product or computer program having program code that can be stored on a machine-readable carrier or storage medium such as a semiconductor memory, a hard drive memory, or an optical memory, and that is used to carry out, realize, and/or control the steps of the method according to one of the specific embodiments described above, in particular when the program product or program is executed on a computer or on a device.

### BRIEF DESCRIPTION OF THE DRAWINGS

FIG. 1 shows a schematic representation of an infrastructure recognition device for a vehicle according to an exemplary embodiment.

FIG. 2 shows a schematic representation of an infrastructure recognition device according to an exemplary embodiment.

FIG. 3 shows a schematic representation of a traffic infrastructure map according to an exemplary embodiment.

FIG. 4 shows a representation of an item of infrastructure information according to an exemplary embodiment.

FIG. 5 shows a representation of an item of infrastructure information according to an exemplary embodiment.

FIG. 6 shows a flow diagram of a method for producing a signal according to an exemplary embodiment.

FIG. 7 shows a flow diagram of a method for providing an item of repair information according to an exemplary embodiment.

FIG. 8 shows a schematic diagram of a device for providing an item of repair information according to an exemplary embodiment.

### DETAILED DESCRIPTION

In the following description of advantageous exemplary embodiments of the present approach, identical or similar reference characters are used for elements shown in the various Figures that have similar functions, and repeated description of these elements is omitted.

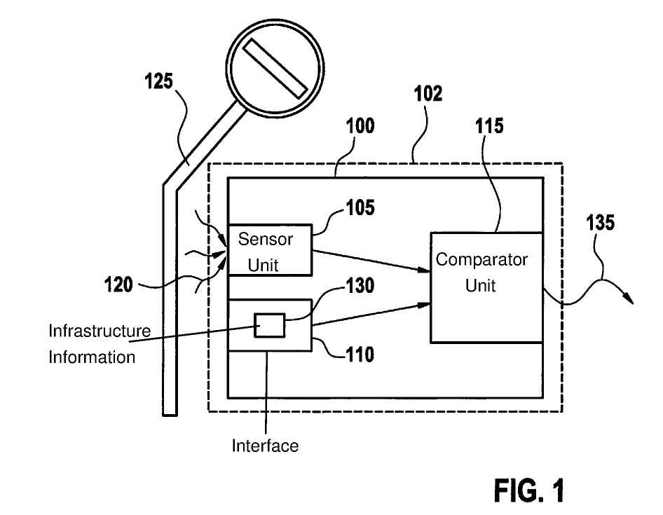

FIG. 1 shows a schematic representation of an infrastructure recognition device 100 for a vehicle 102 according to an exemplary embodiment. In this exemplary embodiment, infrastructure recognition device 100 is situated on vehicle 102. Infrastructure recognition device 100 has a sensor unit 105, an interface 110, and a comparator unit 115. Sensor unit 105 is designed to acquire at least one item of infrastructure information 120 that represents an actual constructive feature of an infrastructure device 125. According to this exemplary embodiment, infrastructure device 125 is a traffic sign. In this exemplary embodiment, the item of infrastructure information 120 is that infrastructure device 125 is bent.

Interface 110 is designed to read in at least one target item of infrastructure information 130 that represents at least one target constructive feature of infrastructure device 125. According to this exemplary embodiment, the target item of infrastructure information 130 is that infrastructure unit 125 is straight. Comparator unit 115 is designed to compare the item of infrastructure information 120 with the target item of infrastructure information 130. Comparator unit 115 is designed to produce a signal 135 if a specified relation exists between the item of infrastructure information 120 and the target item of infrastructure information 130. According to this exemplary embodiment, comparator unit 115 produces signal 135, because item of infrastructure information 120 does not correspond to target item of infrastructure information 130.

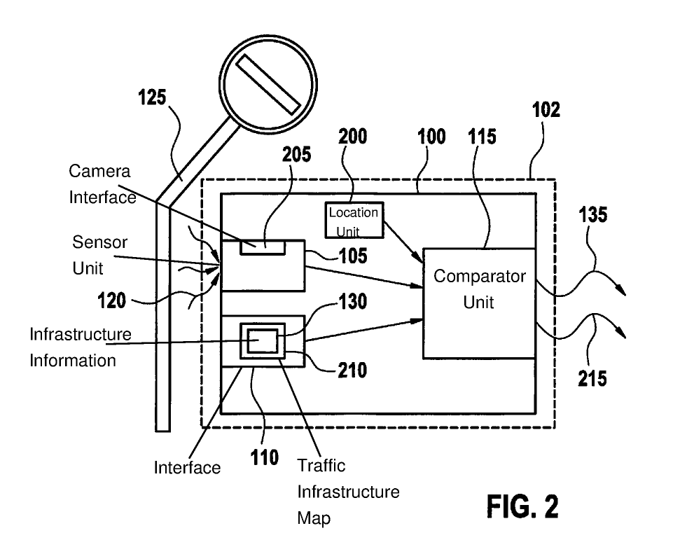

FIG. 2 shows a schematic representation of an infrastructure recognition device 100 according to an exemplary embodiment. This can be infrastructure recognition device 100 described on the basis of FIG. 1. According to this exemplary embodiment, infrastructure recognition device 100 additionally has a location unit 200 for locating infrastructure recognition device 100. According to this exemplary embodiment, sensor unit 105 has a camera interface 205 to a camera. According to this exemplary embodiment, sensor unit 105 is designed to optically acquire item of infrastructure information 120. According to this exemplary embodiment, interface 110 is designed to provide target item of infrastructure information 130 via a traffic infrastructure map 210. Traffic infrastructure map 210 can be a 3-D traffic infrastructure map. According to this exemplary embodiment, comparator unit 115 is designed to wirelessly send, in response to signal 135, an item of repair information 215 to a receive location external to vehicle 102.

In the following, details described above are explained again in more detail on the basis of FIG. 2.

The system presented in the approach described here, in the form of infrastructure recognition device 100 for recognizing maintenance-relevant traffic infrastructure, enables the detection of constructive or significant changes of traffic-regulating infrastructure in the form of infrastructure devices 125, and describes a service for providing this information, via signal 135 and/or item of repair information 215, to, for example, local authorities, for evaluating whether the safety requirements are being met by such infrastructure components, such as infrastructure device 125.

Constructive changes to infrastructure devices 125, such as a bent street sign in this exemplary embodiment, or, in an alternative exemplary embodiment, an disconnected light signal, are ascertained by comparing at least one item of onboard sensor information, in the form of item of infrastructure information 120, with at least one item of, in this exemplary embodiment, 3-D information in the form of target infrastructure information 130 of a locally used digital traffic infrastructure map 210, and subsequently informing a server service about this change via item of repair information 215. In addition, according to this exemplary embodiment, if a camera is connected to camera interface 205 a video image of this change can automatically be acquired, the video image can be referenced by location unit 200, for example using GPS, and this information can additionally be provided to the server service via item of repair information 215.

The task of the presented infrastructure recognition device 100 is the recognition of constructive differences, or differences significant for traffic, of a currently encountered infrastructure device 125, having a reference description in the form of target item of infrastructure information 130, which in this exemplary embodiment is taken from a highly precise digital map, traffic infrastructure map 210. In addition, video images of the identified localities can be generated, georeferenced, and provided to a downstream backend service, e.g. a connected civil engineering or roadway construction office, for further evaluation.

The presented infrastructure recognition device 100 includes for example the following components:
a 3-D reference map in the form of traffic infrastructure map 210, having semantic information in the form of items of target infrastructure information 130 concerning the constructive features that are to be monitored of infrastructure devices 125, such as traffic signs, light signals, and the like; in addition, these items of target infrastructure information 130 are georeferenced.
an environmental sensor system in the form of sensor unit 105, e.g. based on a driver assistance system software product and expanded software products for processing the sensor information in the form of infrastructure information 120, and for extracting the 3-D information in the form of target infrastructure information 130 of the constructive features that are to be monitored of infrastructure devices 125.
location unit 200 for locating the current position of vehicle 102 in traffic infrastructure map 210, e.g. using GPS with map matching, and/or via an onboard sensor-based localization.
comparator unit 115, for comparing the items of infrastructure information 120 acquired by vehicle 102 concerning the infrastructure devices 125 to be monitored with the target items of infrastructure information 130 of traffic infrastructure map 210. Here, the 3-D deviation of the objects in the form of infrastructure devices 125 is determined e.g. by box fitting and/or a comparison of the height and width of the enclosing items, i.e. infrastructure devices 125. The difference is recognized if a specified threshold value is exceeded and/or fallen below.

According to this exemplary embodiment, infrastructure recognition device 100 is designed to carry out a georeferencing of the identified constructive features in the form of items of infrastructure information 120. This takes place for example through an extraction of the nearest street and house number, naming of the infrastructure device 125 (“traffic sign”), and attaching the produced video image to item of repair information 215.

In addition, vehicle 102 can have a data connection for transmitting traffic infrastructure map 210 to vehicle 102 and for transmitting a recognized change from vehicle 102 to the server, including the video images and geotags.

The advantages of the presented infrastructure recognition device 100 are:
Value-added data service for technologies that can be foreseen to be required for the introduction of highly automated and fully automated driving;
Saving personnel costs for officials for providing expert evaluations;
Avoiding angering citizens in cases in which safety-critical damage is not quickly repaired;
Increasing comfort and safety standards of roadways through the possibility of rapid acquisition.

Possible areas of use of the approach presented here are:

CC: Networked functions services, map-based business

AA, INST: Cloud-based mobility services

CC-DA: Obtaining information for digital maps during automated driving

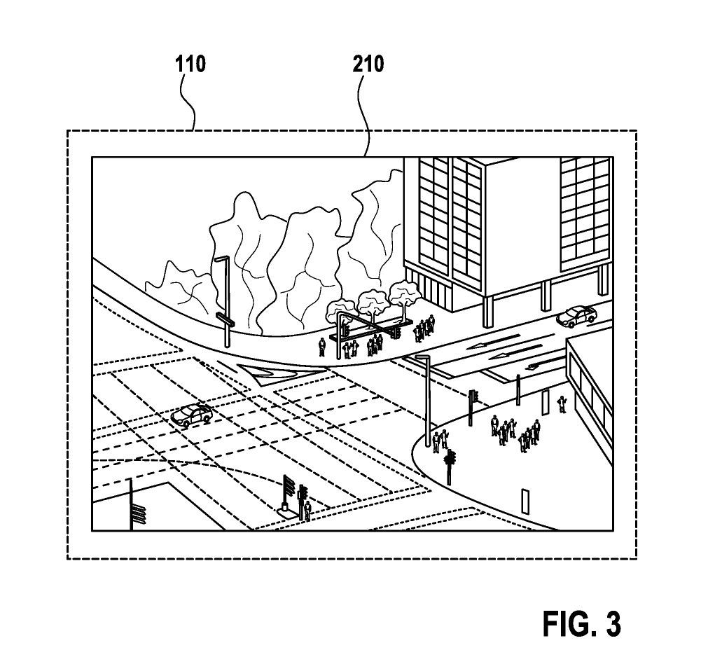

FIG. 3 shows a schematic representation of a traffic infrastructure map 210 according to an exemplary embodiment. This can be infrastructure map 210 described on the basis of FIG. 3.

According to this exemplary embodiment, infrastructure map 210 shows a 3-D representation of an urban traffic scene, recorded using laser sensors. Here it will be recognized that infrastructure map 210 includes highly precise 3-D information in the form of infrastructure target information concerning, for example, street geometries, light signals, light poles, and the like.

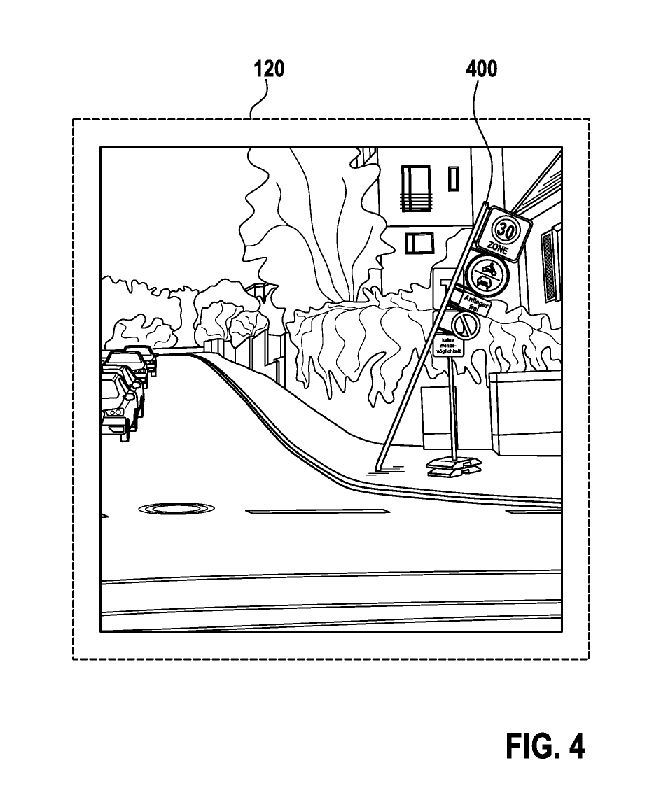

FIG. 4 shows a representation of an item of infrastructure information 120 according to an exemplary embodiment. This can be item of infrastructure information 120 described on the basis of FIG. 2, with the difference that in this exemplary embodiment, item of infrastructure information 120 represents another bent traffic sign 400.

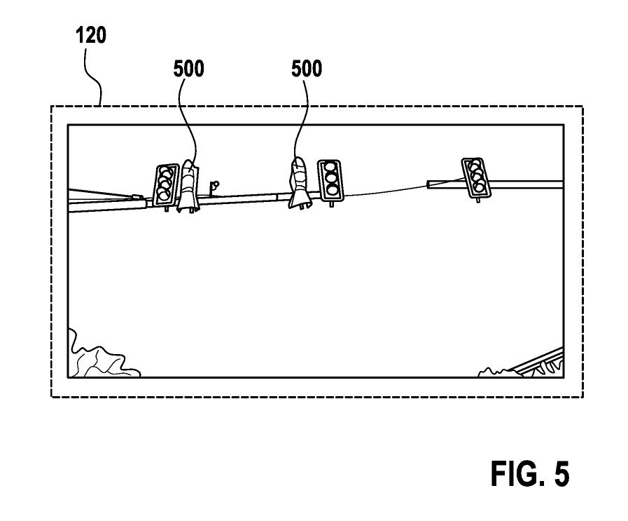

FIG. 5 shows a representation of an item of infrastructure information 120 according to an exemplary embodiment. This can be infrastructure information 120 described on the basis of FIG. 2, with the difference that according to this exemplary embodiment, infrastructure information 120 represents two disconnected light signals 500.

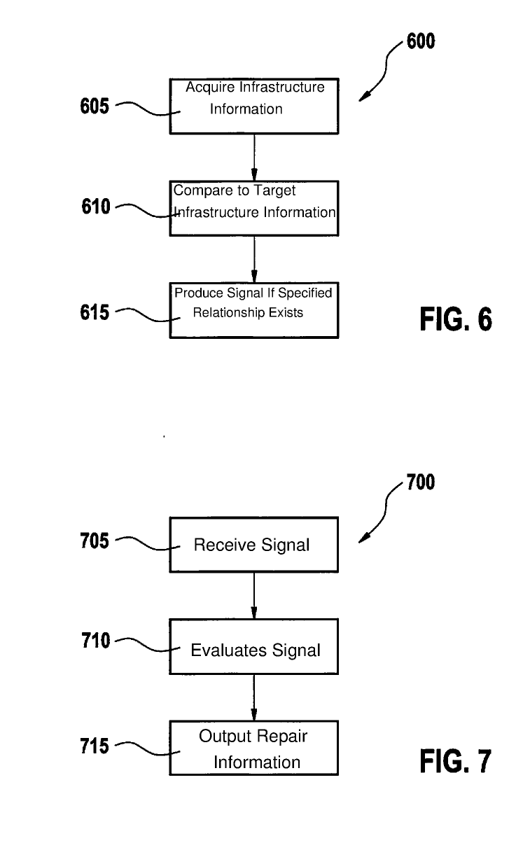

FIG. 6 shows a flow diagram of a method 600 for producing a signal according to an exemplary embodiment. This can be a method 600 for producing the signal described on the basis of FIG. 1. In a step 605 of acquisition, at least one item of infrastructure information that represents at least one actual constructive feature of an infrastructure device is acquired. In a further step 610 of comparison, the item of infrastructure information is compared with a target item of infrastructure information that represents at least one target constructive feature of the infrastructure device. In a final step of producing 615, the signal is produced if there exists a specified relation between the item of infrastructure information and the target item of infrastructure information.

FIG. 7 shows a flow diagram of a method 700 for providing an item of repair information according to an exemplary embodiment. This can be a method 700 for providing the item of repair information described on the basis of FIG. 2. In a step 705 of receiving, the signal described on the basis of FIG. 1 is received. In a further step 710 of evaluation, the signal is evaluated. In a final step 715 of outputting, the item of repair information is outputted with location information of the infrastructure device that is to be repaired.

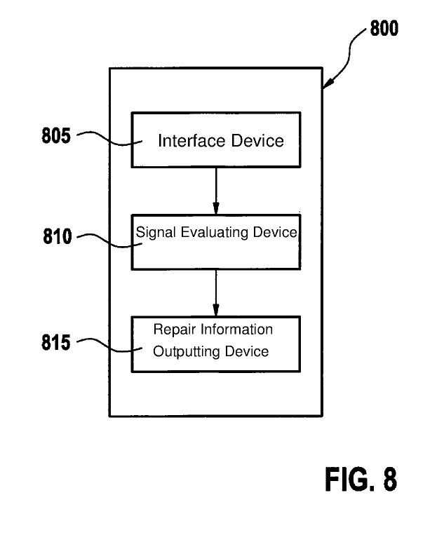

FIG. 8 shows a schematic diagram of a device 800 for providing an item of repair information 215, device 800 having an interface device 805 for receiving a signal 135 according to a variant described above. In addition, device 800 has a device 810 for evaluating signal 135 and a device 815 for outputting item of repair information 215 with location information of infrastructure device 125 to be repaired.

If an exemplary embodiment has an “and/or” linkage between a first feature and a second feature, this is to be read as meaning that according to one specific embodiment the exemplary embodiment has both the first feature and the second feature, and according to another specific embodiment the exemplary embodiment has either only the first feature or only the second feature.

1.-12. (canceled)

13. An infrastructure recognition device for a vehicle, comprising:
a sensor unit for acquiring at least one item of infrastructure information that represents at least one actual constructive feature of an infrastructure device;
an interface for reading in at least one item of target infrastructure information that represents at least one target constructive feature of the infrastructure device; and
a comparator unit for comparing the item of infrastructure information with the item of target infrastructure information, wherein the comparator unit produces a signal when a specified relation exists between the item of infrastructure information and the item of target infrastructure information.

14. The infrastructure recognition device as recited in claim 13, wherein the infrastructure recognition device includes a location unit for locating the infrastructure recognition device.

15. The infrastructure recognition device as recited in claim 13, wherein the sensor unit includes a camera interface to a camera, and wherein the sensor unit optically acquires the item of infrastructure information.

16. The infrastructure recognition device as recited in claim 13, wherein the comparator unit wirelessly sends, in response to the signal, an item of repair information to a receive location situated external to the vehicle.

17. The infrastructure recognition device as recited in claim 16, wherein the item of repair information includes at least one video image of the item of infrastructure information.

18. The infrastructure recognition device as recited in claim 13, wherein the interface provides the target infrastructure information using a traffic infrastructure map.

19. The infrastructure recognition device as recited in claim 18, wherein the traffic infrastructure map one of represents and forms a 3-D traffic infrastructure map.

20. A method producing a signal, comprising:
acquiring at least one item of infrastructure information that represents at least one actual constructive feature of an infrastructure device;
comparing the item of infrastructure information with an item of target infrastructure information that represents at least one target constructive feature of the infrastructure device; and
producing the signal when a specified relation exists between the item of infrastructure information and the target item of infrastructure information.

21. A method for providing an item of repair information, comprising:
receiving a signal produced as follows:
acquiring at least one item of infrastructure information that represents at least one actual constructive feature of an infrastructure device,
comparing the item of infrastructure information with an item of target infrastructure information that represents at least one target constructive feature of the infrastructure device, and
producing the signal when a specified relation exists between the item of infrastructure information and the target item of infrastructure information;
evaluating the signal; and
outputting the item of repair information with location information of the infrastructure device that is to be repaired.

22. A device for providing an item of repair information, comprising:
an arrangement for receiving a signal produced as follows:
acquiring at least one item of infrastructure information that represents at least one actual constructive feature of an infrastructure device,
comparing the item of infrastructure information with an item of target infrastructure information that represents at least one target constructive feature of the infrastructure device, and
producing the signal when a specified relation exists between the item of infrastructure information and the target item of infrastructure information;
an arrangement for evaluating the signal; and
an arrangement for outputting the item of repair information with location information of the infrastructure device that is to be repaired.

23. A computer program that is set up to at least one of carry out and control a method for providing an item of repair information, the method comprising:
receiving a signal produced as follows:
acquiring at least one item of infrastructure information that represents at least one actual constructive feature of an infrastructure device,
comparing the item of infrastructure information with an item of target infrastructure information that represents at least one target constructive feature of the infrastructure device, and
producing the signal when a specified relation exists between the item of infrastructure information and the target item of infrastructure information;
evaluating the signal; and
outputting the item of repair information with location information of the infrastructure device that is to be repaired.

24. A machine-readable storage medium on which a computer program is stored that is set up to at least one of carry out and control a method for providing an item of repair information, the method comprising:
receiving a signal produced as follows:
acquiring at least one item of infrastructure information that represents at least one actual constructive feature of an infrastructure device,
comparing the item of infrastructure information with an item of target infrastructure information that represents at least one target constructive feature of the infrastructure device, and
producing the signal when a specified relation exists between the item of infrastructure information and the target item of infrastructure information;
evaluating the signal; and
outputting the item of repair information with location information of the infrastructure device that is to be repaired.
